(19) United States
(12) Patent Application Publication
(10) Pub. No.: US 2003/0075963 A1
(43) Pub. Date: Apr. 24, 2003

(54) Automobile seat with folding seat back

(75) Inventor: Ralf Oberbeck, Wunstorf (DE)

Correspondence Address: Bourque & Associates, P.A., Suite 301, 835 Hanover Street, Manchester, NH, 03104, US

(73) Assignee: Faurecia Autositze GmbH & Co. KG

(21) Appl. No.: 10/264,800

(22) Filed: Oct. 4, 2002

(30) Foreign Application Priority Data
Oct. 24, 2001 (DE) 101 52 556.7

(51) Int. Cl. B60N 2/06

(52) U.S. Cl. 297/344.1; 297/341; 248/430

(57) ABSTRACT

An automobile seat includes a seat back that is mounted on the seat body that pivots forward about a pivot axis, and two parallel seat rails on which the automobile seat is connected with the chassis so that it may be displaced longitudinally. Each of the seat rails includes base rails attached to the chassis and a slide rail that may be displaced longitudinally with respect to the base rail. The slide rail may be displaced via an electrical spindle drive that includes a drive motor, a drive spindle, and a spindle nut mounted thereon. The spindle nut is formed in two parts along the rotational axis of the drive spindle, and its parts may be moved into and out of engagement with the drive spindle via an actuation device. By means of the separation of the two parts of the spindle nut via the actuation device, they are not engaged, so that the slide rail is free to slide along the base rail.

### TECHNICAL FIELD

The invention relates to an automobile seat slide release mechanism and more particularly, to a release mechanism including a two-piece spindle nut that can be released from contact with a drive spindle by means of an actuator device.

### BACKGROUND INFORMATION

For a known type of automobile seat such as disclosed in DE 44 40 116 A1, a drive motor is connected with a threaded spindle from which various gears are available. For this purpose, the various gears must be capable of being optionally engaged or disengaged. This also applies to the longitudinal position adjustment drive force formed by a separate spindle nut attached to the chassis and by the driven threaded spindle. In this solution, the automobile seat is secured against unwanted longitudinal displacement in any operating position. This securing is provided either by internal limitation of the drive train with drive spindle and spindle nut, or by removal of this internal limitation by means of disengaging the spindle nut by means of cogs provided on its parts that engage in ratcheting apertures of the slide rail. Longitudinal adjustment during failure of the electrical drive is neither provided nor possible. When such automobile seats are provided in two-door vehicles, the rear passengers are trapped in the automobile when the electric drive fails.

An easy-entry device is also known for front seats of two-door vehicles such as disclosed in DE 697 00 556 T2 that disengages the longitudinal adjustment drive from the longitudinal adjustment slide rail. When the front seat back is folded forward, a spindle nut forming part of the longitudinal adjustment drive is separated from the base rail of the longitudinal adjustment slide rail by means of a Bowden cable, and it can be displaced longitudinally along with the slide rail to which the automobile seat is attached. The Bowden cable acts on a locking stud that is mounted in the base rail so that it may be displaced. This easy-entry device can no longer be activated if the seat back can no longer be folded forward, such as after a crash. Also, in such a critical case, the users of the rear seat in a two-seat vehicle are trapped.

### SUMMARY OF THE INVENTION

Starting with the above-mentioned state of the art, it is the task of the invention to configure an automobile seat of the known type so that it may be disengaged even along the longitudinal direction in an emergency.

The invention features an automobile seat with a seat back (2) mounted about a rotational axis (2a) on the seat body (1) so that it may folded forward, with two parallel seat rails (4) on which the automobile seat is attached to the chassis so that it may be displaced longitudinally. The seat rails (4) include base rails (4a) designed to be secured to the chassis, and slide rails (4b) each of which slides longitudinally on these base rails. A slide rail (4b) is displaceable by an electric spindle drive mechanism(5) that includes a drive motor, a drive spindle (5b), and a spindle nut (5a) mounted on the drive spindle. The spindle nut formed of two parts along the rotational axis (5d) of the drive spindle (5b), and whose parts (5e, 5f) may be moved into and out of engagement with the drive spindle (5b) by means of an actuation device (6). By separation of the spindle parts (5e; 5f) via the actuation device (6), these parts are brought out of engagement with the drive spindle (5b), and that the slide rail (4b) is free to move with respect to the base rail (4a).

In this solution, a sufficiently-large access aperture for rear passengers to exit from a two-door vehicle may be created manually either in an emergency or when the electrical power fails. Moreover, unintentional longitudinal displacement of the automobile seat under normal conditions is safely prevented.

Advantageous embodiments of the invention may be taken from the dependent claims recited herein.

### BRIEF DESCRIPTION OF THE DRAWINGS

These and other features and advantages of the present invention will be better understood by reading the following detailed description, taken together with the drawings wherein:

FIG. 1 a schematic lateral view of an automobile seat;

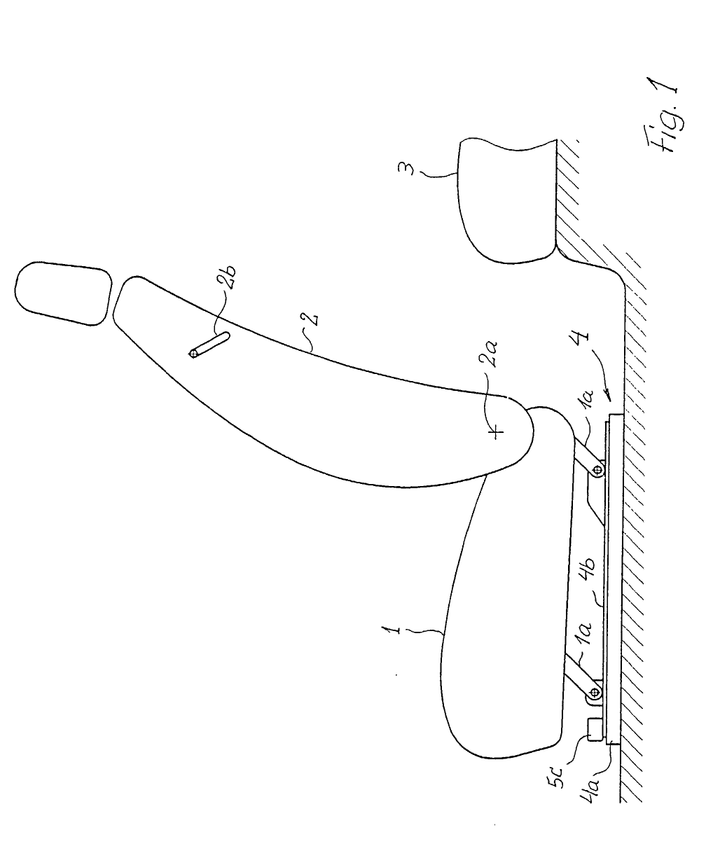

FIG. 2 a perspective view of a seat rail for the automobile seat as in FIG. 1;

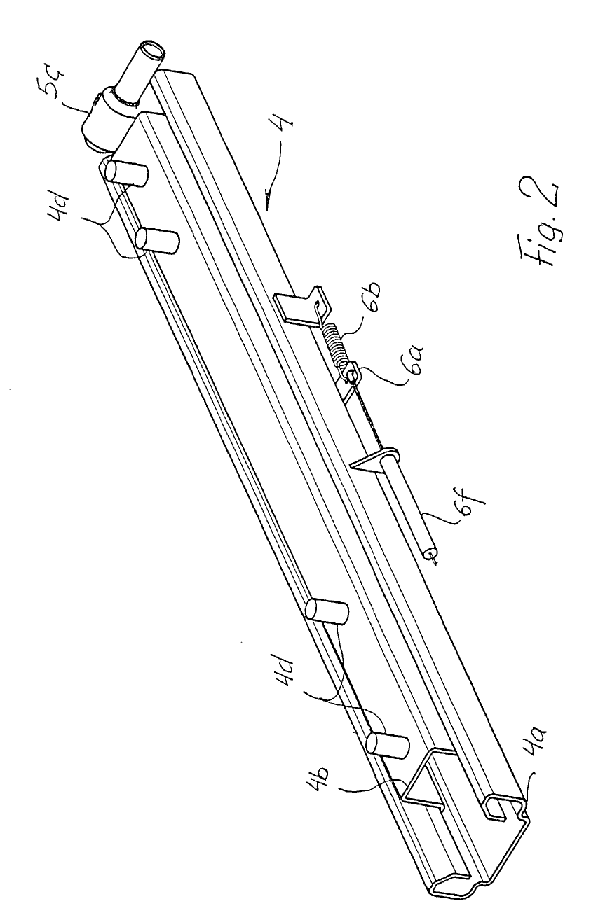

FIG. 3 a perspective view of a base rail of the seat rail per FIG. 2 with a spindle drive;

FIG. 4 the perspective view of a base rail of the seat rail per FIG. 3 with the spindle drive in forward position of a slide rail;

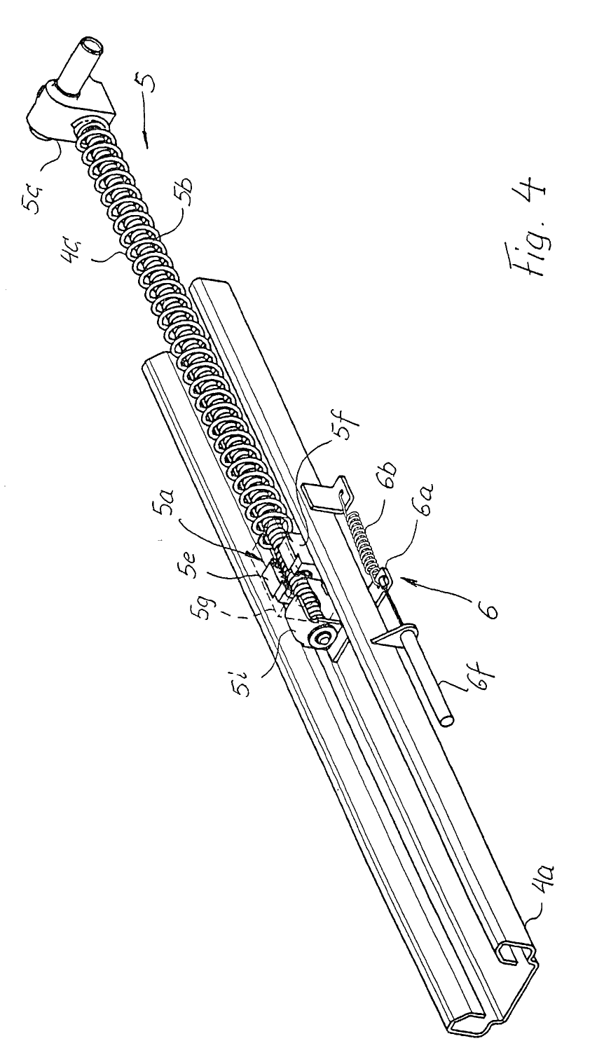

FIG. 5 a schematic view of the spindle nut of the spindle drive per FIG. 3;

FIG. 6 a view along the projection VI-VI in FIG. 5;

FIG. 7 section of the nut area of the slide rail per FIG. 2 in horizontal projection;

FIG. 8 a section corresponding to FIG. 6 with opened spindle nut; and

FIG. 9 a section per FIG. 7 in a condition of the spindle drive corresponding to FIG. 8.

### DETAILED DESCRIPTION OF THE PREFERRED EMBODIMENT

An automobile seat includes a seat body 1 and a seat back 2 that is mounted on the seat body 1 so that it may fold forward about a pivot axis 2a. A swinging lever 2b is actuated to fold the seat back 2 forward. The seat body 1 is connected via longitudinal spars 1a ( two of 4 shown) with parallel seat rails 4, of which only one is shown in the illustrations. Each of these seat rails 4 includes a chassis-mounted base rail 4a and a sliding rail 4b mounted on it so that it may be displaced longitudinally. The slide rail 4b is provided -with securing studs 4d to secure the longitudinal spar 1a to the seat rails 4.

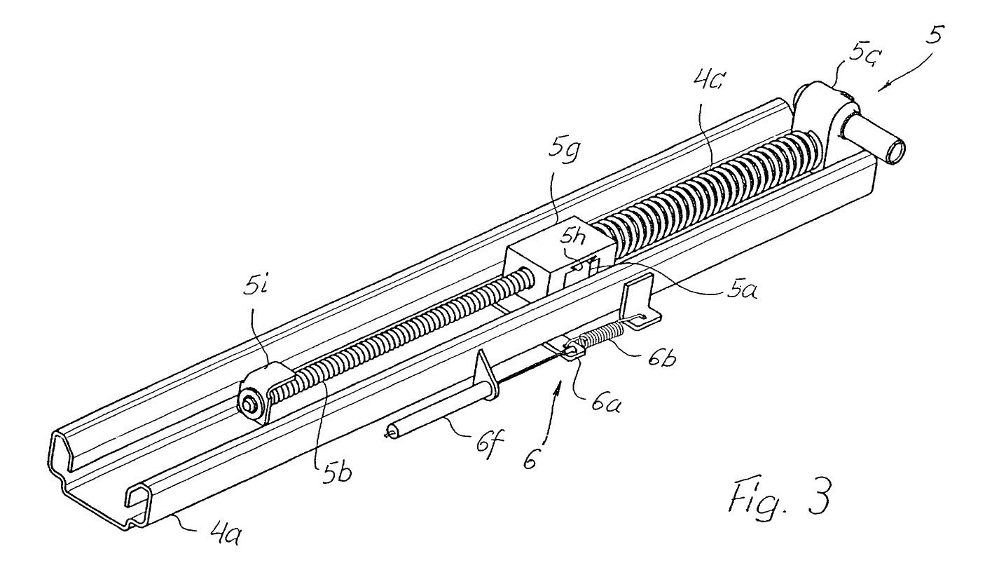

A spindle drive mechanism indicated generally at 5, FIG. 3, that includes an electrical drive motor (not shown) connected to a drive transmission 5c is used to adjust the seat position longitudinally. When the seat back 2 is folded forward by means of the actuation lever 2b, the seat body 1 is additionally manually displaced forward along the seat rail 4 in order to enlarge the access aperture to the rear seat 3.

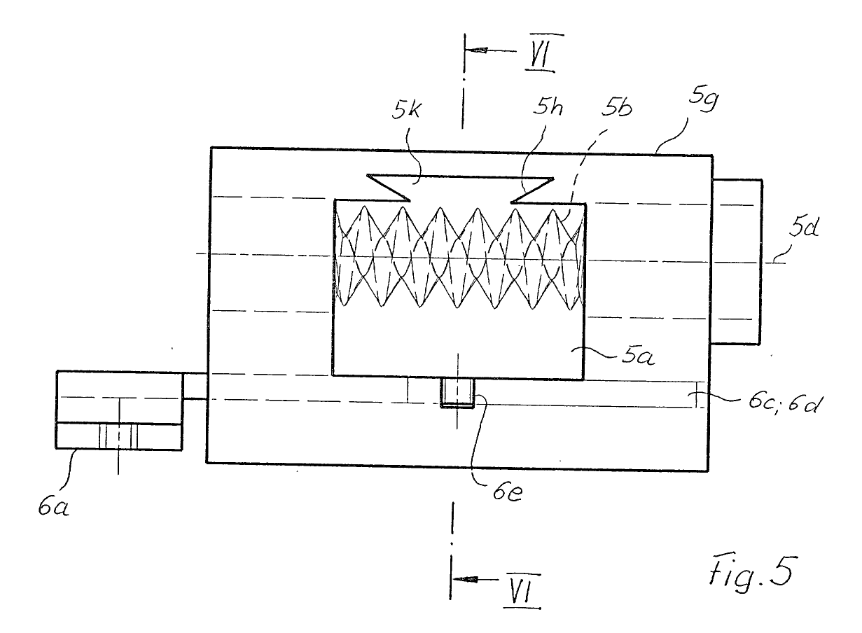

As shown in FIGS. 3 and 5, the drive transmission 5c is firmly connected with a drive spindle 5b that may rotate about a rotation axis 5d that transfixes the spindle nut 5a mounted in a housing 5g. The drive spindle 5b is mounted in a bearing flange 5i connected with the slide rail 4b so that it may rotate. The spindle nut 5a is formed of two pieces along a vertical plane extending toward the rotational axis 5d. Both parts 5e and 5f of the spindle nut 5a are free to move opposite each other back and forth perpendicular to the rotational axis 5d by means of an actuation device 6.

The actuation device 6 is actuated via the swiveling lever 2b that is connected via a Bowden cable 6f with an actuation lever 6a. The actuation lever 6a transfixes the base rail 4a in a slot 4e. On the end of the actuation lever 6a a return spring 6b is mounted that maintains tension on the Bowden cable 6f, that tensions the swivel lever 2b in its initial position, and that tensions the parts 5e and 5f of the spindle nut 5a in its locked position, in which the spindle nut 5a surrounds the thread flanks of the drive spindle 5b. The other end of the return spring 6b is firmly hooked to the base rail 4a. The drive spindle 5b is surrounded by a spring 4c that rests with one end on the housing 5g and the other on the drive transmission 5c. The spring 4c simplifies manual displacement of the seat body 1 for easy entry.

Cross guide spars 5h are positioned within the housing 5g perpendicular to the rotational axis 5d and are formed as a dovetail to displace the two parts 5e and 5f of the spindle nut 5a. They support matching guide areas 5k of the parts 5e and 5f. On the side of the spindle nut 5a opposite the guide areas 5k, connecting links 6e formed as lugs are positioned on both parts 5e and 5f of the spindle nut 5a that engage in the connecting links 6c and 6d connected with the actuation lever 6a.

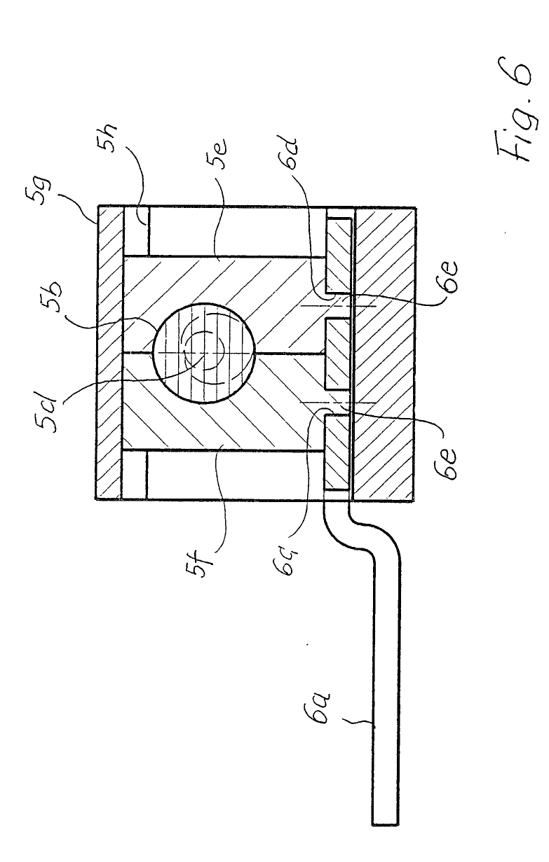

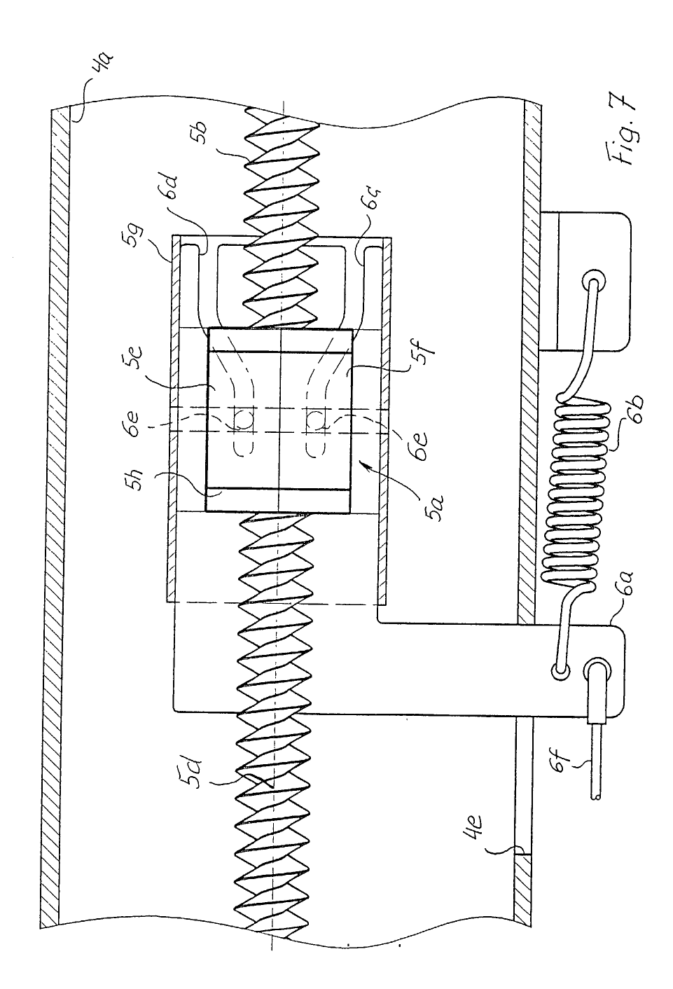

The connecting links 6c and 6d include areas parallel to each other and only slightly separated, and areas parallel to each other but more greatly separated. When the connecting links 6e are positioned within the areas of the connecting links 6c and 6d as they approach each other, the spindle nut 5a is closed, and it engages with the thread of the drive spindle 5b, as shown in FIGS. 6 and 7. Rotation of the drive spindle 5b by the drive motor thus leads to displacement of the slide rails 4b along the longitudinal direction. A force acting from without on the automobile seat cannot displace the seat because the spindle drive 5 is configured to be self-limiting.

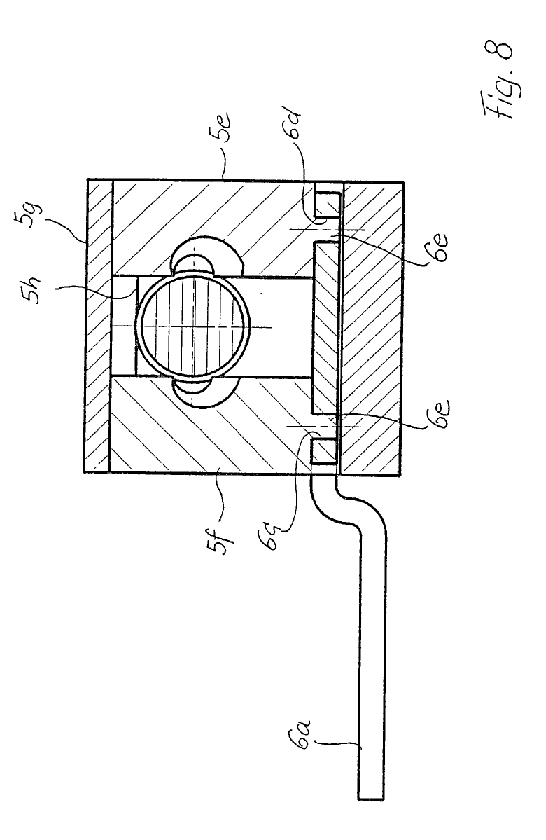

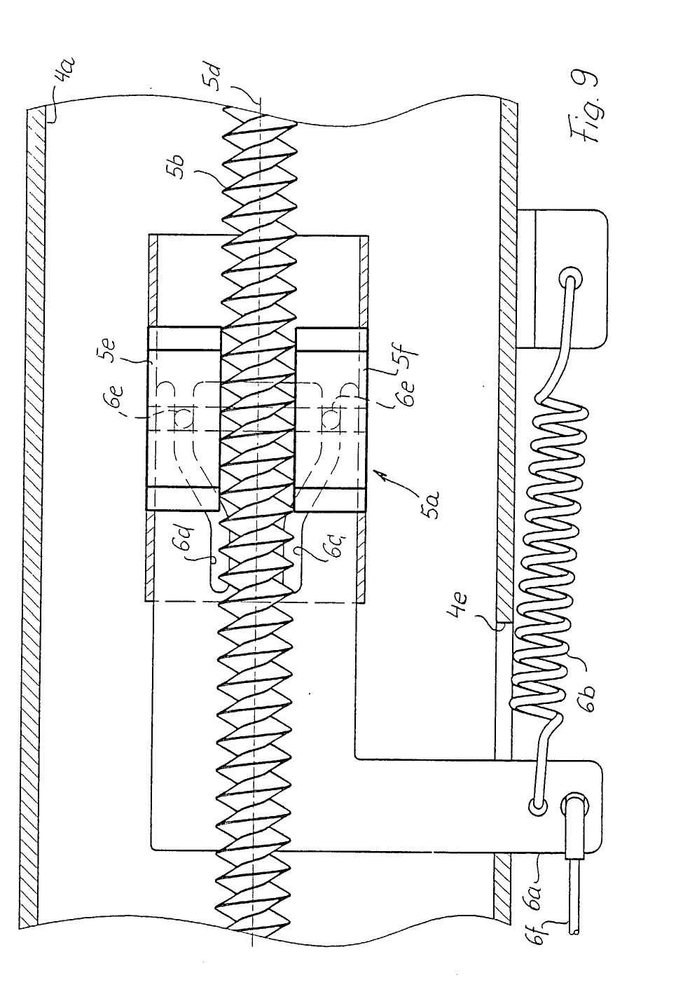

Displacement of the connecting links 6c and 6d toward the rotational axis 5d into the position shown in FIG. 9 leads to the separation of the two parts 5e and 5f of the spindle nut 5a, as shown in FIG. 8. Thus, the drive spindle 5b is released. Rotation of the drive spindle 5b now leads to no displacement of the automobile seat which may, however, be manually displaced into either final position by exercising force on the seat back 2 while folding it backward or forward. After release of the swivel lever 2b, the actuation lever 6a is immediately moved together with the connecting link guides 6c and 6d by the return spring 6b into the locked position of the spindle nut 5a, so that unintentional displacement of the automobile seat is not possible.

Modifications and substitutions by one of ordinary skill in the art are considered to be within the scope of the present invention which is not to be limited except by the claims which follow.

The claimed invention is:

1. An automobile seat comprising:
a seat back (2) mounted about a rotational axis (2a) on the seat body (1) so that it may folded forward;
two parallel seat rails (4) on which the automobile seat is attached to the chassis so that it may be displaced longitudinally, said seat rails (4) including base rails (4a) securable to the chassis, and slide rails (4b) each of which slides longitudinally on these base rails; and
said slide rails (4b) displaceable by an electric spindle drive mechanism (5) that includes a drive motor, a drive spindle (5b), and a spindle nut (5a) mounted on the drive spindle, said spindle nut formed of two parts along the rotational axis (5d) of the drive spindle (5b), said two parts (5e; 5f) are moveable into and out of engagement with the drive spindle (5b) by means of an actuation device (6) wherein by separation of the two parts (5e; 5f) via the actuation device (6), the two parts of the spindle nut are brought out of engagement with the drive spindle (5b), and wherein the slide rail (4b) is free to move with respect to the base rail (4a).

2. The automobile seat as in claim 1, wherein the actuation device (6) includes an actuation lever (6a) that may be displaced with respect to the two part spindle nut (5a).

3. The automobile seat as in claim 1, wherein the two parts (5e; 5f) of the spindle nut (5a) are pre-tensioned in the direction of the rotational axis (5d) of the drive spindle (5b) via a return spring (6b).

4. The automobile seat as in claim 1, wherein the actuation device (6) includes a connecting link guide (6c; 6d) into which connecting elements (6e) are free to move toward the rotational axis (5d) and perpendicular to the rotational axis (5d).

5. The automobile seat as in claim 4, wherein the connecting links (6e) are connected with the parts (5e; 5f) of the spindle nut (5a), and the connecting link guide (6c; 6d) are connected with the moveable actuation lever (6a).

6. The automobile seat as in claim 4, wherein the connecting links (6e) are formed as studs.

7. The automobile seat as in claim 4, wherein the connecting links (6c, 6d) and the connecting link guide (6a) are mounted so that together they may be displaced along the direction of the rotational axis (5d).

8. The automobile seat as in claim 3 wherein one end of the return spring (6b) is attached to the chassis and the other end is attached to the actuation lever (6a).

9. The automobile seat as in claim 1 wherein the two parts (5e; 5f) of the two-part spindle nut (5a) are displaced perpendicular to the rotational axis (5d).

10. The automobile seat as in claim 9, wherein a cross guide path (5h) is provided within a housing (5g) as a guide for the two parts of the spindle nut (5e; 5f).

11. The automobile seat as in claim 10, wherein the cross guide path (5h) is formed as a dovetail guide.

12. The automobile seat as in claim 1 wherein the slide rail (4b) is pre-tensioned forward along the vehicle longitudinal direction by a spring (4c).
